(19) United States
(12) Patent Application Publication
(10) Pub. No.: US 2005/0119380 A1
(43) Pub. Date: Jun. 2, 2005

(54) Polypropylene resin composition

(75) Inventor: Toshiyuki Iwashita, Oita City, Oita Prefecture (JP)

Correspondence Address: BASELL USA INC., INTELLECTUAL PROPERTY, 912 APPLETON ROAD, ELKTON, MD, 21921, US

(73) Assignee: Basell Poliolefine Italia S.p.A, Milan (IT)

(21) Appl. No.: 10/502,102

(22) PCT Filed: Jan. 16, 2003
(86) PCT No.: PCT/EP03/00399

(30) Foreign Application Priority Data
Jan. 24, 2002 (JP) 2002-15859

(51) Int. Cl. C08L 1/00

(52) U.S. Cl. 524/183; 524/543

(57) ABSTRACT

A polypropylene composition comprising (C) one or more compound(s) selected from the group consisting of oxides of the group 2 or the group 12 metals of the periodic table and metal alkoxides, added in an amount of from 0.01 to 2 weight parts to 100 weight parts of a resin component prepared by subjecting 100 weight parts of a resin component comprising (A) from 10 to less than 80 weight parts of a polypropylene component having a melt flow rate of from 0.1 to 300 g/10 min and (B) from 90 to more than 20 weight parts of an olefin copolymer rubber component having an intrinsic viscosity [η] of from 0.5 to 5.0 dl/g to a treatment of irradiating with an ionizing radiation and/or a melt treatment after adding from 0.05 to 5 weight parts of an organic peroxide.

The present invention relates to a polypropylene-series resin composition. The polypropylene-series resin composition excellent in impact resistance, rigidity, and moldability can be prepared by using the polypropylene-series resin composition of this invention as an ingredient added to other resins.

Particularly, the present invention relates to a polypropylene-series resin composition made of a kneaded product prepared by melt kneading either an metallic compound or a metal alkoxide with a polypropylene component and an olefinic copolymer rubber component having undergone a treatment of irradiating with an ionizing radiation or a treatment with an organic peroxide, and a polypropylene-series resin composition high in impact resistance and rigidity, excellent in moldability, and colorless which is prepared by blending this polypropylene-series resin composition with a polypropylene-series resin.

Polypropylene-series resins in general are widely used as industrial materials such as automobile components, electrical and electronic parts and a variety of wrapping materials by making use of properties of being inexpensive and moreover characteristics such as lightness in weight, chemical resistance, acid resistance, and heat resistance. However, with demands for high-performance products and reduction in costs, improvement in characteristics of these materials has been strongly desired in recent years.

For the purpose of improving the impact resistance of these characteristics, a method of blending an ethylene-propylene copolymer rubber is proposed (e.g., Japanese Patent Publication No. 57049/1982, Japanese Patent Publication No. 5460/1987, etc.). However, since the polypropylene content is low, these methods leave problems in reduction in the rigidity and heat resistance.

Therefore, for the purpose of improving the impact resistance of polypropylene, a number of methods of combining a variety of rubbers such as ethylene-propylene copolymer rubber with propylene-ethylene block copolymers (Heterophasic copolymer by polymerization polymer blend) having comparatively excellent rigidity and impact resistance of polypropylenes with a nucleating agent have been proposed (Japanese Patent Publication No 3420/1985, etc.).

Furthermore, a method of adding an ethylene-propylene copolymer rubber and an ethylene-series copolymer, and an inorganic filler to polypropylene is proposed (e.g., Japanese Patent Laid-Open No. 276351/1992, Japanese Patent Laid-Open No. 98097/1993, Japanese Patent Laid-Open No. 98098/1993, Japanese Patent Laid-Open No. 5051/1993, etc.).

However, these conventional methods all improve part of the characteristics of the polypropylene-series resins, but are insufficient in improvement in the impact resistance and rigidity.

The present invention is carried out under the circumstances and aims at providing a polypropylene-series resin composition high in the rigidity and impact resistance, colorless, and excellent in the moldability.

The present inventors have intensively studied and as a result, found that a polypropylene-series resin composition prepared by subjecting a mixture of a particular polypropylene component and an olefinic copolymer rubber component having an intrinsic viscosity [η] of from 0.5 to 5.0 dl/g to a treatment of irradiating with an ionizing radiation and/or a treatment with an organic peroxide, adding a small amount of an metal alkoxide or an oxide of a particular metal of the group 2 or the group 12 of the periodic table to the aforesaid mixture, and melt kneading is added to another resin such as polypropylene, and furthermore a nucleating agent is added thereby to obtain a resin composition excellent in rigidity, impact resistance, and elongation, achieving the aforesaid aim. This invention has been accomplished on the basis of the findings.

That is, the polypropylene-series resin composition of the first form of this invention is a polypropylene-series resin composition where (C) at least one compound selected from the group consisting of oxides of the group 2 or the group 12 metals of the periodic table and metal alkoxides represented by the following general formula (I) is added in an amount of from 0.01 to 2 weight parts to 100 weight parts of a resin component prepared by subjecting 100 weight parts of a resin component comprising (A) from 10 to less than 80 weight parts of a polypropylene component having a melt flow rate of from 0.1 to 300 g/10 min and (B) from 90 to more than 20 weight parts of an olefinic copolymer rubber component having an intrinsic viscosity [η] of from 0.5 to 5.0 dl/g to a treatment of irradiating with an ionizing radiation and/or a melt treatment after adding from 0.05 to 5 weight parts of an organic peroxide.
M(R)ₘ₋ₙ(OR′)ₙ (I)
(In the formula, R and R′ each represent an alkyl group having a carbon number of from 1 to 20, m is 3 or 4, n is an integer of m≧n≧2, and M represents boron (B), aluminum (Al), silicon (Si), or an metallic atom of the group 4 or the group 5 of the periodic table.)

The polypropylene-series resin composition of the second form of this invention is a polypropylene-series resin composition comprising from 1 to 40 weight parts of the aforesaid polypropylene-series resin composition of the first form and (D) from 99 to 60 weight parts of a polypropylene-series resin having a melt flow rate of from 0.1 to 300 g/10 min.

Furthermore, the polypropylene-series resin composition of the third form of this invention is a polypropylene-series resin composition prepared by adding (E) from 0.05 to 20 weight parts of a nucleating agent per 100 weight parts of the aforesaid polypropylene-series resin composition of the second form.

Preferred modes for carrying out this invention are described in detail below.

In the present invention the polypropylene component used as component (A) is a homopolymer of propylene or a polymer consisting of propylene and another α-olefin which has a melt flow rate of from 0.1 to 300 g/10 min. Herein, the α-olefin includes ethylene, 1-butene, 1-pentene, 1-hexene, 1-heptene, 1-octene, 1-decene, 4-methyl-1-pentene, and the like. The amount of the α-olefin polymerized in the polymer of propylene and the α-olefin is preferably 10 weight percent at most. These resins can be used singly or as mixtures of two or more thereof. Polymerization of these resins can be carried out, for example, by use of Ziegler-Natta catalyst or metallocene catalyst according to known procedures.

The amount of the α-olefin exceeding 10 weight percent in the copolymer of propylene and the α-olefin is not preferable because roughness is observed on the strand on pelletizing with an extruder and the rigidity reduces in some cases depending upon an irradiation dose and the kind of the organic peroxide, when the treatment of irradiating with an ionizing radiation or the treatment with an organic peroxide has been carried out.

The melt flow rate of the aforesaid polypropylene component ranges from 0.1 to 300 g/10 min, in general from 0.2 to 280 g/10 min, further preferably from 0.2 to 260 g/10 min, and particularly preferably from 0.3 to 250 g/10 min. Too low a value of the melt flow rate may disturb uniform blending of the polypropylene component (A) with the olefin-series copolymer rubber component (B) or may cause gelation on treating with an organic peroxide, depending upon the kind of the organic peroxide. On the other hand, too high a value of the melt flow rate may disturb uniform blending with the copolymer rubber on the treatment of irradiating with an ionizing radiation or the treatment with an organic peroxide or may increase the melt flow rate by the treatment with an organ peroxide depending upon the kind thereof, which makes it difficult to pelletize by melt kneading. Or the impact resistance may not be improved in some cases by subjecting component (A) and component (B) to the treatment of irradiating with an ionizing radiation or the treatment with an organic peroxide, adding component (C), and thereafter melt kneading with component (D). Component (A) of this invention may be one kind or mixtures of two or more kinds.

The melt flow rates in this invention are values measured at 230° C. under a load of 2.16 kg according to JIS K7210, and hereinafter occasionally referred to as the “MFR.”

The olefinic copolymer rubber component of component (B) used in this invention is a component obtained by copolymerizing two or more units stemming from olefins such as olefins and diolefins. Examples of component (B) include ethylene-propylene copolymer rubbers, ethylene-butene copolymer rubbers, ethylene-propylene-non-conjugated diene copolymer rubbers, styrene-ethylene/isoprene-styrene block copolymer rubbers (SEPS), styrene-ethylene/butylene-styrene block copolymer rubbers (SEBS), block copolymer rubbers of propylene and another α-olefin, and the like. Of these, the ethylene-propylene copolymer rubbers, the ethylene-butene copolymer rubbers, and the block copolymer rubbers of propylene and another α-olefin are preferred. The intrinsic viscosities [η] measured in tetralin of 135° C. of these are from 0.5 to 5.0 dl/g, preferably from 0.8 to 4.9 dl/g, and particularly preferably from 1.0 to 4.8 dl/g. The intrinsic viscosity less than 0.5 dl/g disturbs the desired effect to be expected by adding component (B) to component (A), carrying out the treatment of irradiating with an ionizing radiation or the treatment with an organic peroxide, and adding component (C). On the other hand, exceeding 5.0 dl/g may unpreferably cause gelation on the treatment of irradiating with an ionizing radiation or the treatment with an organic peroxide.

The content of the olefinic copolymer rubber component of (B) is from more than 20 to 90 weight parts, preferably from 25 to 85 weight parts, and particularly preferably from 30 to 80 weight parts. When the content is less than 20 weight parts, uniformity may be prevented after subjecting component (A) and component (B) to the treatment of irradiating with an ionizing radiation or the treatment with an organic peroxide and adding component (C) or improvement in the impact resistance can not be expected in some cases by adding component (C), melt kneading, and thereafter adding to component (D).

On the other hand, when component (B) exceeding 90 weight parts is used, strand cut may become difficult on the treatment of irradiating with an ionizing radiation and the treatment with an organic peroxide or on melt kneading after adding component (C), uniform blending may be disturbed on melt kneading with component (D), or reduction in rigidity may occur depending upon the composition in some cases.

The olefinic copolymer rubbers used as component (B) can be used singly or as mixtures of two or more thereof. Component (B) can be prepared by use of the known Ziegler-Natta catalyst or metallocene catalyst according to known procedures.

Methods for blending component (A) and component (B) include a method of preparing the respective components and melt kneading these and a method of polymerizing component (A) and component (B) according to a procedure of preliminary polymerization or multi-stage polymerization in one polymerization system. For example, a method of preparing component (A) in the first stage and subsequently preparing component (B) in the second stage, that is, a method of preparing a heterophasic copolymer by polymerization polymer blend.

Subsequently, in the present invention, procedures according to which the resin component comprising component (A) and component (B) undergoes the treatment of irradiating with an ionizing radiation and/or the treatment with an organic peroxide are described. Component (A) and component (B) are mixed and subjected to these treatments or component (A) and component (B) are subjected to either of the treatments, respectively, and then mixed. In this case, the procedures of the treatments of the respective components may be different from each other.

The treatment of irradiating with an ionizing radiation can be carried out on a melt kneaded product comprising the polypropylene component of component (A) and the olefinic copolymer rubber component of component (B) or can be separately carried out on component (A) and component (B) wherein the respective irradiation doses can be different from each other. The form of the product to be treated can be any form of pellet, powder, and pulverized particle. The irradiation can be carried out under vacuum, in an atmosphere of an inert gas, or in an atmosphere of the air, but is desirably carried out in an atmosphere of the air in view of costs and operation.

The ionizing radiation includes X-rays, electron rays, γ rays, α rays, and so forth, but γ rays are preferred in view of transmission. The irradiation dose in general is preferably from 1 to 80 kGy, more preferably from 2 to 70 kGy, and particularly preferably from 5 to 50 kGy. In the irradiation dose less than 1 kGy, the desired effect can not be expected by adding component (C) and melt kneading. Exceeding 80 kGy may cause gelation and deteriorate moldablilty depending upon the composition and, for example, when the polypropylene-series resin composition is formed into a strand, a fine strand may not be obtained in some cases.

The treatment with an organic peroxide may be carried out after melt kneading component (A) and component (B), or may be separately carried out on component (A) and component (B) and in this case, the respective amounts of the organic peroxide may be different.

In the treatment with the organic peroxide, component (A), component (B), the organic peroxide, and additives are blended by use of a Henschel mixer or a ribbon mixer, and desirably melt kneaded according to the aforesaid procedure generally at a temperature of from 160 to 280° C. and preferably from 170 to 260° C. though the temperature depends upon the half-life period of the organic peroxide.

In the treatment with the organic peroxide, a reactor or the like is used, and component (A), component (B), and the organic peroxide can be mixed, treated with stirring in an atmosphere of an inert gas at a temperature of 40 to 150° C. for from 2 min to 3 hr, and thereafter pelletized with an extruder.

Diacyl peroxides, peroxy esters, and peroxy dicarbonates are preferred as the organic peroxides used for the treatment with the organic peroxide. Examples of the organic peroxides include lauroyl peroxide, dicumyl peroxide, isobutyl peroxide, octanol peroxide, stearoyl peroxide, succinperoxide, t-butylperoxy-2-ethylhexylhexanol, t-butylperoxy isobutylate, t-hexylperoxy-2-ethylhexanol, t-hexylperoxy pivalate, t-butylperoxy-2-ethylhexyl monocarbonate, benzoyl peroxide, m-toluenebenzyl peroxide, diisoprdpylperoxy carbonate, di-n-propylperoxy dicarbonate, bis(3-methoxybutyl)peroxy carbonate, bis(4-t-butylcyclohexyl)peroxy carbonate, dicetylperoxy dicarbonate, di-2-ethylhexylperoxy dicarbonate, dimyristylperoxy dicarbonate, and the like. Of these, bis(4-t-butylcyclohexyl)peroxy dicarbonate, dicetylperoxy dicarbonate, and benzoyl peroxide are preferred. These organic peroxides can be used singly or as mixtures of two or more thereof.

In the present invention, component (A) or component (B) having undergone the treatment of irradiating with the ionizing radiation and component (A) or component (B) having undergone the treatment with the organic peroxide can be jointly used.

The oxides of the group 2 or the group 12 metals of the periodic table (C) (hereinafter referred to as the “metal oxides”) used in this invention include zinc oxide, cadmium oxide, magnesium oxide, calcium oxide, barium oxide, and the like.

Specific examples of the metal alkoxides represented by general formula (I) include aluminum isopropoxide, diethylaluminum diethoxide, titanium(IV) tetrabutoxide, titanium(III) triethoxide, diethyltitanium(IV) diisopropoxide, boron tripropoxide, texylboran dimethoxide, vanadium(IV) tetrabutoxide, zirconium(IV) tetraethoxide, and the like. In addition, the aforesaid metal alkoxides can be those having polymer structures such as dimer or trimer where the aforesaid metal alkoxides are linked together through a three-center two-electron bond.

In the present invention, commercially available products can be used as such as the metal oxides and metal alkoxides, and the purity of 95% or more will do in this case. The content of the metal oxides or the metal alkoxides is from 0.01 to 2 weight parts, preferably from 0.02 to 1.8 weight parts and particularly preferably from 0.03 to 1.5 weight parts to 100 weight parts of the resin component comprising component (A) and component (B) having undergone the treatment of irradiating with the ionizing radiation or the treatment with the organic peroxide. The content less than 0.01 weight part is small in an effect acquired by adding to component (A) and component (B) having undergone the treatment of irradiating with the ionizing radiation or the treatment with the organic peroxide and melt kneading. On the other hand, exceeding 2 weight parts makes it possible to acquire a constant effect, but is unpreferable in view of coloring, odor, and costs.

The polypropylene-series resin composition of this invention can be used in the form of the polypropylene-series resin component comprising component (A) and component (B) having undergone the aforesaid treatments and component (C), but preferably used by blending this composition with another resin, and particularly the polypropylene-series resin composition prepared by blending the composition with component (D) is preferred.

The polypropylene-series resins used as component (D) include homopolymers of propylene and random or block copolymers of propylene and other α-olefins, for example, ethylene, 1-butene, 1-pentene, 1-hexene, 1-heptene, 1-octene, 1-decene, 4-methyl-1-pentene, and the like. Of these, propylene block copolymers are preferred in view of the mechanical strength, oil resistance, and heat resistance.

The propylene block copolymers are those containing from 95.0 to 30 weight parts of crystalline propylene polymer portions and from 5 to 70 weight parts of elastomer portions where the content of other α-olefins is preferably from 3 to 60 weight percent.

These polymers can be manufactured by use of the Ziegler-Natta catalyst or metallocene catalyst according to known procedures similarly to those as described above as to the propylene-series resins of component (A). These polymers can be used singly or as mixtures of two or more thereof.

The melt flow rate of the polypropylene-series resins of component (D) is preferably from 0.5 to 300 g/10 min, further preferably from 0.7 to 280 g/10 min, and particularly preferably from 1.0 to 250 g/10 min. The melt flow rate (Hereinafter occasionally referred to as the “MFR”) of the polypropylene-series resins of component (D) is a value measured according to JIS K7210 at 230° C. under a load of 2.16 kg.

In the present invention, component (D) itself does not undergo the treatment of irradiating with the ionizing radiation and the treatment with the organic peroxide. That is, this invention aims at improving the impact resistance, rigidity, and elongation of the component (D) by adding component (D) to the melt kneaded product where component (C) is added to component (A) and component (B) having undergone the treatment of irradiating with the ionizing radiation and the treatment with the organic peroxide.

About the content of component (D), the polypropylene-series resin of component (D) is from 99 to 60 weight parts of component (D) to from 1 to 40 weight parts of the aforesaid treated product comprising component (A), component (B), and component (C), and particularly the polypropylene-series resin of component (D) desirably ranges from 98 to 62 weight parts to from 2 to 38 weight parts of the aforesaid treated product. The content of component (D) can be less than 60 weight parts, but the rigidity reduces depending upon the composition. On the other hand, exceeding 99 weight parts causes no problem in the rigidity, but may cause reduction in the impact resistance in some cases.

The nucleating agent (E), which exerts an effect of growing crystals as nuclei for crystals by adding the agent to crystalline resins such as polypropylene in the field of synthetic resins, can be added to the resin composition of this invention. Useful nucleating agents include, for example, metal salts of carboxylic acids, dibenzylsorbitol derivatives, alkali metal salts of phosphate, inorganic compounds such as talc, and the like.

Specific examples of the Nucleating agents include sodium benzoate, aluminum adipate, aluminum p-t-butylbenzoate, 1,3,2,4-dibenzylidenesorbitol, 1,3,2,4-bis(p-methyl-benzylidene)sorbitol, 1,3,2,4-bis(p-ethylbenzylidene)sorbitol, 1,3-p-chlorobenzylidene-2,4-p-methylbenzylidene)sorbitol, sodium bis(4-t-butylphenyl)phosphate, sodium bis(4-t-methylphenyl)phosphate, potassium bis(4,6-di-t-butylphenyl)phosphate, sodium 2,2′-methylene-bis(4,6-di-t-butylphenyl)phosphate, sodium 2,2′-ethylidene-bis(4,6-di-t-butylphenyl)phosphate, and talc, calcium carbonate, and the like.

The content of the nucleating agent in general is preferably from 0.05 to 20 weight parts to 100 weight parts of the polypropylene resin composition, and a preferred ratio depends upon the kind thereof. For example, in the case of the organic-series agents excluding inorganic compounds, the content in general is from 0.05 to 1 weight part, preferably from 0.08 to 0.8 weight part, and particularly preferably from 0.1 to 0.5 weight part. On the other hand, in the case of the inorganic compounds such as talc, the content in general is from 1 to 18 weight parts and particularly preferably from 5 to 15 weight parts.

When the inorganic compounds are used, the compounds treated with surface treatments such as titanate-series, silane-series, and aluminum-series coupling agents, aliphatic acids, aliphatic metal salts, or aliphatic esters, etc. can be used.

When the polypropylene-series resin compositions of the first to third forms are prepared in this invention, various additives can be blended. Although the formulation of the additives used herein is not particularly limited, the preferred formulation of additives is a combination of a phenolic antioxidant, a phosphite-series additive, and calcium stearate. Tetrakis[methylene-3-(3′,5′-di-t-4-hydroxyphenyl)propionate]methane and n-octadecinyl-3-(4′-hydroxynyl)propionate are particularly preferred as the phenolic antioxidants. The content of the phenolic antioxidant in general ranges from 0.001 to 2 weights parts and preferably from 0.002 to 1.8 weight parts, and particularly preferably from 0.005 to 1.5 weight parts.

Tris(2,4-di-t-butylphenyl)phosphite is preferred as the phosphite additive. The content of the phosphite in general ranges from 0.001 to 1.5 weight parts, preferably from 0.005 to 1.5 weight parts, and particularly preferably from 0.01 to 1.0 weight part.

The content of calcium stearate in general ranges from 0.01 to 2 weight parts, preferably from 0.02 to 1.5 weight parts, and particularly preferably from 0.03 to 1.5 weight parts.

Moreover, a variety of conventional additives, for example, antioxidants, weathering stabilizers, antistatic agents, lubricants, antifogging agents, improvers of electrical characteristics, processing stabilizers, pigments, softeners can be added as needed as long as the object of this invention is not deteriorated.

In order to prepare the polypropylene-series resin compositions of the first to third forms, it is preferable that first a mixture of component (A) and component (B) is subjected to the treatment of irradiating with the ionizing radiation or the organic peroxide is blended with a mixture of component (A) and component (B) and melt kneaded. About blending of component (C), for example, component (C) is added to the resin component of component (A) and component (B) having undergone the treatment of irradiating with the ionizing radiation or the treatment with the organic peroxide and blended with a Henschel mixer, etc. or component (A) and component (B) are treated with the organic peroxide and after the organic peroxide disappears, component (C) is fed through the side feeder. Component (A) and component (B) having undergone the treatment of irradiating with an ionizing radiation also can be similarly added through the side feeder and melt kneaded. This resin is preferably pelletized.

Furthermore, component (A) is subjected to the treatment of irradiating with the ionizing radiation or the treatment with the organic peroxide and subsequently component (B) is subjected to the treatment of irradiating with the ionizing radiation or the treatment with the organic peroxide, and thereafter the component (A) and the component (B) are mixed in the aforesaid range, component (C) is added similarly to the preceding and melt kneaded. In this case, the mixture can be melt kneaded after dry blending and then pelletized.

Component (D) and/or component (E) are dry blended or blended by use of a Henschel mixer with the poypropylene-series resin composition comprising the treated product of component (A) and component (B) and component (C), and thereafter melt kneaded. After that, pelletizing can be done.

Methods for mixing the resins having undergone the treatment of irradiating with the ionizing radiation or the treatment with the organic peroxide include a method of mixing by use of a Henschel mixer, a ribbon mixer, etc. and subsequently melt kneading by use of a kneading machine such as mixing roll, Banbury mixer, kneader, extruder, etc. When the melt kneading is carried out, the temperature in general ranges from 170 to 280° C. and preferably from 180 to 260° C.

In the pelletizing of the resin mixture, known procedures can be used and, for example, the strand cut method where a strand is extruded from an extruder, cooled with water, and cut into a constant length can be preferably used.

Furthermore, component (A) or component (B) having undergone the treatment of irradiating with the ionizing radiation and component (B) or component (A) having undergone the treatment with the organic peroxide can be added in the aforesaid range, subsequently component (C) can be added and melt kneaded, and component (D) or component (E) can be added to these and melt kneaded.

The first form of this invention is a composition prepared by using the base resin of the polypropylene-series resin of component (A) and the copolymer rubber of component (B), subjecting the base resin to the treatment of irradiating with the ionizing radiation or the treatment with the organic peroxide (formation of the composition can be carried out after undergoing the treatments separately), adding a metal oxide or a metal alkoxide to the resulting polypropylene-series resin, and melt kneading.

The second form of this invention is a resin composition prepared by mixing component (D) with the propylene-series resin of the aforesaid first form in the aforesaid range, and brings about improvement, in the impact resistance and elongation without reduction in the moldability and rigidity.

In the third form of this invention, component (E) is added to the polypropylene-series resin composition of the second form of this invention and then melt kneaded, thereby to further improve the rigidity and impact resistance without further reducing the elongation.

The present invention is hereinafter illustrated through specific examples in further detail.

### EXAMPLES

The respective physical properties as described below were measured according to the following methods.

(1) Measurement of MFR

The measurement was carried out according to JIS K7210 under condition 14 described in Tab. 1.

(2) Content of Comonomer

Determined on a nuclear magnetic resonance (¹³C-NMR) spectrometer and an infrared spectrophotometer.

(3) The intrinsic viscosity [η] was measured in tetralin at 135° C.

(4) The modulus of elasticity in bending was measured according to ASTM D790.

(5) The Izod impact strength was measured according to JIS K7110 with notch.

(6) The elongation in the tensile test was measured according to JIS K7113.

(7) Appearance of Polypropylene-Series Resin Composition

Component (C) was added, and a strand on pelletizing was inspected with the naked eye and evaluated according to the three grades as described below.

∘: Strand is not rough, but fine.

Δ: Strand feels rough.

x: Strand is rough and does not keep the original form.

The respective materials used in the following examples and comparative examples are as follows.

Component (A)

The following are used as the polypropylene-series resins for component (A).

Homopolypropylene having an MFR of 0.58 g/10 min (Hereinafter referred to as “PP-A”).

Homopolypropylene having an MFR of 2.5 g/10 min (Hereinafter referred to as “PP-B”).

Ethylene-propylene random copolymer having an ethylene content of 1.2 weight percent and an MFR of 4.2 g/10 min (Hereinafter referred to as “PP-C”).

Homopolypropylene having an MFR of 0.03 g/10 min (Hereinafter referred to as “PP-D”).

Homopolypropylene having an MFR of 350 g/10 min (Hereinafter referred to as “PP-E”).

Component (B)

The following are used as the olefinic copolymer rubbers for component (B).

An ethylene-propylene copolymer rubber having an intrinsic viscosity [η] of 1.9 dl/g and an ethylene content of 73.5 weight percent (Hereinafter referred to as “B-1”).

An ethylene-propylene copolymer rubber having an intrinsic viscosity [η] of 2.5 dl/g and an ethylene content of 74.2 weight percent (Hereinafter referred to as “B-2”).

An ethylene-propylene copolymer rubber having an intrinsic viscosity [η] of 3.1 dl/g and an ethylene content of 70.4 weight percent (Hereinafter referred to as “B-3”).

An ethylene-propylene copolymer rubber having an intrinsic viscosity [η] of 0.46 dl/g and an ethylene content of 74.2 weight percent (Hereinafter referred to as “B-4”).

An ethylene-butene copolymer rubber having an intrinsic viscosity [η] of 2.4 dl/g and an ethylene content of 85 weight percent (Hereinafter referred to as “B-5”).

(A)-(B) Heterophasic Copolymers

A heterophasic copolymer obtained by preparing 44 weight percent of homopolypropylene at the first stage and preparing 56 weight percent of an ethylene-propylene copolymer rubber (Ethylene content: 47 weight percent) at the second stage was used as component (A) and component (B) having undergone polymerization blend (Hereinafter referred to as “BPP-1”).

Herein, the MFR of the homopolypropylene at the first stage was 87 g/10 min, and [η] of the ethylene-propylene copolymer rubber was 3.5 dl/g.

Tetrakis[methylene-3-(3′, 5′-di-t-hydroxyphenyl)-propionate]methane, tris(2,4-di-t-butylphenyl)phosphite, and calcium stearate were used as the additives.

Dicetylperoxy dicarbonate (Hereinafter referred to as “PO-1”), bis(4-t-butylcyclohexyl)peroxy carbonate (Hereinafter referred to as “PO-2”), and benzoyl peroxide (Hereinafter referred to as “PO-3”) were used as the organic peroxides, respectively.

Magnesium oxide (Manufactured by Wako Jun-yaku Kogyo K. K., Purity: 99.8 weight percent, Hereinafter referred to as “C-1”) and aluminum isopropoxide (Manufactured by Wako Jun-yaku Kogyo K. K., Purity: 98.2 weight percent, Hereinafter referred to as “C-2”) were used as the metal oxide and the metal alkoxide for component (C), respectively.

An ethylene-propylene block copolymer having an MFR of 27 g/10 min and an ethylene content of 9.4 weight percent (Hereinafter referred to as “PP-1”), an ethylene-propylene block copolymer having an MFR of 18 g/10 min and an ethylene content of 9.1 weight percent (Hereinafter referred to as “PP-2”), and an ethylene-propylene block copolymer having an MFR of 120 g/10 min and an ethylene content of 7.5 weight percent (Hereinafter referred to as “PP-3”) were used as the polypropylene-series resins for component (D), respectively.

Sodium 2,2-methylene-bis(4,6-di-t-butylphenyl)phosphate (Trade name: NA11, Manufactured by Asahi Denka Kogyo K. K.) was used as component (E).

### Examples 1 to 4

### The First Form of this Invention

### Comparative Examples 1 to 5

The polypropylene-series resins and the copolymer rubbers as shown in the following Table 1 were used as component (A) and component (B), respectively, and 0.05 PHR of tetrakis[methylene-3-(3′, 5′-di-t-hydroxyphenyl)propionate]methane, 0.03 PHR of tris(2,4-di-t-butylphenyl)phosphite, and 0.08 PHR of calcium stearate were added thereto, and pelletized with a 40-mmφ extruder produced by Yoshii Tekko K. K. (Temperature: 190° C.).

Irradiation with a γ radiation was applied to the resulting pellets by use of γ radiation-irradiating apparatus (Manufactured by Koga Isotope Company) in an atmosphere of the air with doses as shown in Table 1. Component (C) as shown in Table 1 was added to the pellets irradiated with the γ radiation and pelletized with the 40-mmφ extruder produced by Yoshii Tekko K. K. (Temperature: 210° C.). Herein, the pellets to which component (C) was not added also were pelletized similarly. The pellets of Examples 1 to 4 having undergone the treatment of irradiating with the γ radiation to which component (C) was added are described as XPP-1 to 4. The pellets of Comparative Examples 1 and 2 having undergone the treatment of irradiating with the γ radiation to which component (C) was not added are described as XPP-5 and 6, and the pellets of Comparative Examples 3 to 5 having undergone the treatment of irradiating with the γ radiation to which component (C) was added are described as XPP-7 to 9.

Results are shown in Table 1.

Results of Table 1 reveal that in Examples 1 to 4 the compositions were mixed well and the strands were good in appearance and colorless.

In Comparative Example 1 the rise in the MFR was large as compared with that in Example 1 and in Comparative Example 2 the rise in the MFR also was large as compared with that in Example 3.

The composition of Comparative Example 3 was low in the MFR, encountered gelation, and bad in the appearance of the strand. The composition of Comparative Example 4 was badly mixed and bad in the appearance of the strand. The composition of Comparative Example 5 was high in the MFR to be difficult in pelletizing.

### Examples 5 to 9

### The First Form of this Invention

### Comparative Examples 6 to 9

Components comprising polypropylene-series resins and copolymer rubbers as shown in Table 2 were used as component (A) and component (B), and similarly to Example 1 additives were added, (PO-1), (PO-2), and (PO-3) were added as the organic peroxides, and pelletized at 190° C. by use of a 40-mmφ extruder produced by Yoshii Tekko K. K. Component (C) was added in ratios as shown in Table 2 to the samples having undergone the treatment with the organic peroxide and similarly pelletized by use of the 40-mmφ extruder produced by Yoshii Tekko K. K. at 190° C. The compositions of Examples 5 to 9 are described as XPP-10 to 14 and the resin compositions of Comparative Examples 6 to 9 are described as XPP-15 to 18.

Results are shown in Table 2.

In Examples 5 to 9 the strands are fine and colorless. In Comparative Example 6 the strand is fine, but large in the rise in the MFR as compared with Example 5. In comparative Example 7 the strand is fine, but large in rise in the MFR as

In Comparative Example 8 gelation is observed and the appearance of the strand also is bad. In Comparative Example 9 the composition is badly mixed and the appearance of the strand also is bad.

### Examples 10 to 17

### The Second Form of this Invention

### Comparative Examples 10 to 13

0.05 Weight part of tetrakis[methylene-3-(3,5-di-t-hydroxyphenyl)propionate] methane, 0.03 weight part of tris(2,4-di-t-butylphenyl)phosphite, and 0.08 weight part of calcium stearate were added as the additives of component (D) to the respective samples of XPP-1 prepared in Example 1, XPP-2 prepared in Example 2, XPP-3 prepared in Example 3, XPP-4 prepared in Example 4, XPP-10 prepared in Example 5, XPP-11 prepared in Example 6, XPP-12 prepared in Example 7, and XPP-14 prepared in Example 9, XPP-5 prepared in Comparative Example 1, XPP-6 prepared in Comparative Example 2, XPP-15 prepared in Comparative Example 6, and XPP-16 prepared in Comparative Example 7, melt kneaded in ratios as shown in Table 3 by use of the 40-mmφ extruder produced by Yoshii Tekko K. K. at a temperature of 190° C., and pelletized.

The resulting pellets were subjected to injection molding by use of an injection molding machine (IS170II-5A model produced by Toshiba Machine Co., Ltd.) at a temperature of 210° C. to prepare test specimens, respectively. About the respective test specimens, the modulus of elasticity in bending, the Izod impact strength, and the elongation in the tensile test were measured.

In Examples 10 to 17 the moduli of elasticity in bending are almost equal as compared with those in Comparative Examples 10 to 13, but the Izod impact strengths are higher than those in the comparative examples and moreover the elongations in the tensile test also are large. In addition, no coloring is observed.

### Examples 18 to 23

### The Third Form of this Invention

### Comparative Examples 14 to 17

Component (D) and component (E) were added in ratios as shown in Table 4 to the respective samples of XPP-1 prepared in Example 1, XPP-2 prepared in Example 2, XPP-3 prepared in Example 3, XPP-12 prepared in Example 7, XPP-13 prepared in Example 8, XPP-14 prepared in Example 9, and XPP-5 prepared in Comparative Example 1, and XPP-6 prepared in Comparative Example 2 together with the formulation and ratios of the same additives as Example 10, blended in a Henschel mixer, subsequently melt kneaded by use of the 40-mmφ extruder produced by Yoshii Tekko K. K. at a temperature of 190° C., and pelletized. Test specimens were prepared from the resulting respective pellets under the same conditions as in Example 10. About the respective test specimens, the modulus of elasticity in bending, the Izod impact strength, and the elongation in the tensile test were measured.

Results are shown in Table 4.

In Examples 18 to 23 and Comparative Examples 14 to 17, the addition of the nucleating agent allows improvement in the moduli of elasticity in bending, and in the examples the impact resistance and the elongation are improved as compared with the comparative examples though there are almost no differences between the examples and the comparative examples.

As described above, the present invention provides a polypropylene-series resin composition excellent in rigidity, impact resistance, and elongation.

TABLE 1

| Examples | Polypropylene | | Copolymer | | Irradiation | | | | | |
|---|---|---|---|---|---|---|---|---|---|---|
| and | series Resin | | Rubber | | Dose of | | | Representation of | | |
| Comparative | | Content | | Content | γ-Radiation | Component (C) | | Polypropylene-Series | MFR | Appearance |
| Examples | | (wt. parts) | | (wt. parts) | (kGy) | | Content | Resin Composition | (g/10 min) | of Strand |
| Example 1 | PP-A | 50 | B-2 | 50 | 25 | C-2 | 0.4 | XPP-1 | 1.3 | ◯ |
| Example 2 | PP-C | 60 | B-1 | 40 | 25 | C-2 | 0.3 | XPP-2 | 2.5 | ◯ |
| Example 3 | PP-B | 50 | B-3 | 50 | 20 | C-1 | 0.4 | XPP-3 | 1.1 | ◯ |
| Example 4 | PP-A | 40 | B-5 | 60 | 25 | C-2 | 0.3 | XPP-4 | 0.8 | ◯ |
| Comparative | PP-A | 50 | B-2 | 50 | 25 | — | — | XPP-5 | 4.2 | ◯ |
| Example 1 | | | | | | | | | | |
| Comparative | PP-B | 50 | B-3 | 50 | 20 | — | — | XPP-6 | 3.9 | ◯ |
| Example 2 | | | | | | | | | | |
| Comparative | PP-D | 50 | B-2 | 50 | 25 | C-2 | 0.3 | XPP-7 | 0.3 | X |
| Example 3 | | | | | | | | | | |
| Comparative | PP-A | 40 | B-4 | 60 | 20 | C-1 | 0.4 | XPP-8 | 8.2 | Δ |
| Example 4 | | | | | | | | | | (Bad Mixing) |
| Comparative | PP-E | 50 | B-1 | 50 | 25 | C-2 | 0.3 | XPP-9 | 130 | Difficult in |
| Example 5 | | | | | | | | | | Pelletizing |

TABLE 2

| Examples | Polypropylene | | | | | | | | Representation of | | |
|---|---|---|---|---|---|---|---|---|---|---|---|
| and | Series Resin | | Copolymer Rubber | | Organic Peroxide | | | | Polypropylene- | | |
| Comparative | | Content | | Content | | Content | Component (C) | | Series Resin | MFT | Appearance |
| Examples | | (wt parts) | | (wt. parts) | | (wt. parts) | | Content | Composition | (g/10 min) | of Strand |
| Example 5 | PP-B | 50 | B-3 | 50 | PO-3 | 0.5 | C-1 | 0.3 | XPP-10 | 1.0 | ◯ |
| Example 6 | PP-C | 60 | B-2 | 40 | PO-1 | 0.3 | C-2 | 0.4 | XPP-11 | 1.7 | ◯ |
| Example 7 | PP-B | 50 | B-1 | 50 | PO-1 | 0.5 | C-1 | 0.3 | XPP-12 | 1.9 | ◯ |
| Example 8 | PP-A | 60 | B-5 | 40 | PO-2 | 0.5 | C-2 | 0.3 | XPP-13 | 0.8 | ◯ |
| Example 9 | First Stage | 44 | Second Stage | 56 | PO-3 | 0.5 | C-2 | 0.3 | XPP-14 | 1.4 | ◯ |
| | of BPP-1 | | of BPP-1 | | | | | | | | |
| Comparative | PP-B | 50 | B-3 | 50 | PO-3 | 0.5 | — | — | XPP-15 | 2.1 | ◯ |
| Example 6 | | | | | | | | | | | |
| Comparative | PP-C | 60 | B-2 | 40 | P0-1 | 0.3 | — | — | XPP-16 | 3.2 | ◯ |
| Example 7 | | | | | | | | | | | |
| Comparative | PP-D | 50 | B-3 | 50 | PO-2 | 0.5 | C-2 | 0.3 | XPP-17 | 0.2 | X |
| Example 8 | | | | | | | | | | | |
| Comparative | PP-A | 60 | B-4 | 40 | PO-3 | 0.5 | C-1 | 0.4 | XPP-18 | 6.8 | Δ |
| Example 9 | | | | | | | | | | | (Bad Mixing) |

TABLE 3

| | | | Resin Composition | | | | | | |
|---|---|---|---|---|---|---|---|---|---|
| | Polypropylene- | | Containing | | | | | | |
| Examples | Series Resin of | | Components | | | Modulus | Izod Impact | | |
| and | Component (D) | | (A), (B), and (C) | | | of Elasticity | Strength | | |
| Comparative | | Content | | Content | MFR | in Bending | 23° C. | −20° C. | Elongation |
| Examples | | (wt. parts) | Name | (wt. parts) | (g/10 min) | (Mpa) | (J/m) | (J/m) | (%) |
| Example 10 | PP-1 | 90 | XPP-1 | 10 | 24.8 | 1580 | 138 | 77 | 210 |
| Example 11 | PP-1 | 90 | XPP-2 | 10 | 25.2 | 1530 | 127 | 72 | 210 |
| Example 12 | PP-2 | 95 | XPP-4 | 5 | 17.1 | 1660 | 112 | 68 | 200 |
| Example 13 | PP-2 | 90 | XPP-3 | 10 | 16.6 | 1510 | 119 | 69 | 190 |
| Example 14 | PP-3 | 95 | XPP-10 | 5 | 102 | 1720 | 92 | 65 | 80 |
| Example 15 | PP-1 | 90 | XPP-12 | 10 | 25.2 | 1580 | 126 | 74 | 210 |
| Example 16 | PP-3 | 90 | XPP-14 | 10 | 101 | 1640 | 91 | 66 | 70 |
| Example 17 | PP-1 | 85 | XPP-11 | 15 | 23.9 | 1460 | 149 | 82 | 210 |
| Comparative | PP-1 | 90 | XPP-5 | 10 | 26.2 | 1520 | 89 | 45 | 110 |
| Example 10 | | | | | | | | | |
| Comparative | PP-1 | 90 | XPP-15 | 10 | 26.3 | 1540 | 93 | 51 | 120 |
| Example 11 | | | | | | | | | |
| Comparative | PP-2 | 85 | XPP-6 | 15 | 15.9 | 1480 | 91 | 48 | 110 |
| Example 12 | | | | | | | | | |
| Comparative | PP-3 | 90 | XPP-16 | 10 | 112 | 1620 | 80 | 43 | 40 |
| Example 13 | | | | | | | | | |

TABLE 4

| | | | Resin Composition | | | | | | | |
|---|---|---|---|---|---|---|---|---|---|---|
| | Polypropylene- | | confaining | | | | | | | |
| Examples | Series Resin of | | Components | | Component | | Modulus of | Izod | | |
| and | Component (D) | | (A), (B), and (C) | | (E) | | Elasticity | Impact-Strength | | |
| Comparative | | Content | | Content | Content | MFR | in Bending | 23° C. | −20° C. | Elongation |
| Examples | | (wt. parts) | Name | (wt. parts) | (wt. parts) | (g/10 min) | (Mpa) | (J/m) | (J/m) | (%) |
| Example 18 | PP-3 | 90 | XPP-1 | 10 | 0.4 | 101 | 2080 | 84 | 57 | 50 |
| Example 19 | PP-1 | 90 | XPP-2 | 10 | 0.4 | 25.3 | 1920 | 110 | 61 | 160 |
| Example 20 | PP-1 | 95 | XPP-3 | 5 | 0.4 | 26.6 | 2010 | 108 | 58 | 170 |
| Example 21 | PP-2 | 90 | XPP-12 | 10 | 0.4 | 17.2 | 1910 | 106 | 57 | 180 |
| Example 22 | PP-3 | 95 | XPP-13 | 5 | 0.4 | 112 | 2120 | 87 | 53 | 40 |
| Example 23 | PP-1 | 90 | XPP-14 | 10 | 0.4 | 25.8 | 1970 | 97 | 55 | 170 |
| Comparative | PP-1 | 90 | XPP-5 | 10 | 0.4 | 26.4 | 1910 | 81 | 41 | 90 |
| Example 14 | | | | | | | | | | |
| Comparative | PP-1 | 90 | XPP-6 | 10 | 0.4 | 26.3 | 1940 | 83 | 44 | 110 |
| Example 15 | | | | | | | | | | |
| Comparative | PP-3 | 95 | XPP-15 | 5 | 0.4 | 114 | 2010 | 60 | 37 | 30 |
| Example 16 | | | | | | | | | | |
| Comparative | PP-2 | 90 | XPP-16 | 10 | 0.4 | 17.4 | 1910 | 80 | 39 | 90 |
| Example 17 | | | | | | | | | | |

1. A polypropylene composition comprising (C) at least one compound selected from the group consisting of oxides of the group 2 or the group 12 metals of the periodic table and metal alkoxides represented by the following general formula (I):
M(R)ₘ₋ₙ(OR′)ₙ (I)
wherein R and R′ each represent an alkyl group having a carbon number of from 1 to 20, m is 3 or 4, n is an integer having values of m≧n≧2, and m represents boron, aluminum, silicone, or a metallic atom of the group 4 or the group 5 of the periodic table;
said compound or compounds (C) being added in an amount of from 0.01 to 2 weight parts to 100 weight parts of a resin component prepared by subjecting 100 weight parts of the resin component comprising (A) from 10 to less than 80 weight parts of a polypropylene component having a melt flow rate of from 0.1 to 300 g/10 min and (B) from 90 to more than 20 weight parts of an olefin copolymer rubber component having an intrinsic viscosity [η] of from 0.5 to 5.0 dl/g to a treatment of irradiating with an irradiation dose of ionizing radiation and/or a melt treatment after adding from 0.05 to 5 weight parts of an organic peroxide.

2. The composition of claim 1 wherein the ionizing radiation is a γ radiation and the irradiation dose thereof is at least 1 kGy and no greater than 80 kGy.

3. A polypropylene composition comprising from 1 to 40 weight parts of (C) at least one compound selected from the group consisting of oxides of the group 2 or the group 12 metals of the periodic table and metal alkoxides represented by the following general formula (I):
M(R)ₘ₋ₙ(OR′)ₙ (I)
wherein R and R′ each represent an alkyl group having a carbon number of from 1 to 20, m is 3 or 4, n is an integer having values of m≧n≧2, and M represents boron, aluminum, silicon, or a metallic atom of the group 4 or the group 5 of the periodic table; said compound or compounds (C) being added in an amount of from 0.01 to 2 weight parts to 100 weight parts of a resin component prepared by subjecting 100 weight parts of the resin component comprising (A) from 10 to less than 80 weight parts of a polypropylene component having a melt flow rate of from 0.1 to 300 g/10 min and (B) from 90 to more than 20 weight parts of an olefin copolymer rubber component having an intrinsic viscosity [η] of from 0.5 to 5.0 dl/g to a treatment of irradiating with an irradiation dose of ionizing radiation and/or a melt treatment after adding from 0.05 to 5 weight parts of an organic peroxide; and (D) from 99 to 60 weight parts of a polypropylene resin having a melt flow rate of from 0.1 to 300 g/10 min.

4. The composition of claim 3 wherein from 0.05 to 20 weight parts of a nucleating agent (E) are added per 100 weight parts of the composition.
